(19) United States
(12) Patent Application Publication
(10) Pub. No.: US 2009/0123711 A1
(43) Pub. Date: May 14, 2009

(54) Disperse azo dyes and mixtures comprising these disperse azo dyes

(76) Inventor: Helmut Sieber, Rheinfelden (DE)

Correspondence Address: CLARIANT CORPORATION;INTELLECTUAL PROPERTY DEPARTMENT, 4000 MONROE ROAD, CHARLOTTE, NC, 28205, US

(21) Appl. No.: 11/921,883

(22) PCT Filed: Jun. 7, 2006
(86) PCT No.: PCT/EP2006/062959

§ 371 Date: Dec. 7, 2007

(30) Foreign Application Priority Data
Jun. 9, 2005 (EP) 05105096.1
Aug. 17, 2005 (EP) 05107566.1

(51) Int. Cl. B32B 3/00; C09B 29/08; C09D 11/02; B05D 5/00; C09B 67/22

(52) U.S. Cl. 428/195.1; 534/850; 8/696; 8/639; 106/31.45; 427/288

(57) ABSTRACT

Dye of the formula (I)

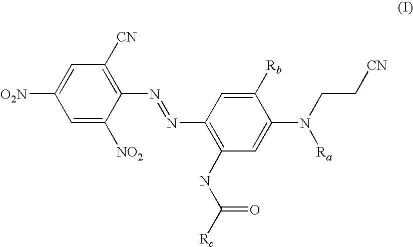

where
Rₐ is —C₆H₅-substituted C₁-C₄-alkyl,
R_{b} is methoxy or ethoxy
R_{c} is methyl or ethyl,
its preparation and also the use of this dye in dye mixtures.

The invention relates to disperse azo dyes, processes for their preparation and also their use for dyeing and printing hydrophobic synthetic materials.

The invention further relates to disperse azo dye mixtures, processes for their preparation and also their use for dyeing and printing hydrophobic synthetic materials.

The present invention has for its object to provide disperse dyes having good application properties and also navy to black disperse dye mixtures having good application properties.

This object is achieved by the dye of the formula (I)

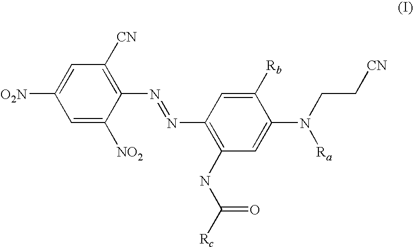

where
Rₐ is —C₆H₅-substituted C₁-C₄-alkyl,
R_{b} is methoxy or ethoxy
R_{c} is methyl or ethyl.

In particularly preferred dyes of the formula (I)

Rₐ is —C₆H₅-substituted C₁-C₂-alkyl but in particular benzyl,
R_{b} is methoxy
R_{c} is methyl.

The invention further also provides a process for preparing the dye of the formula (I).

The process for preparing the novel dyes of the formula (I) is characterized in that a diazotized amine of the formula (II)

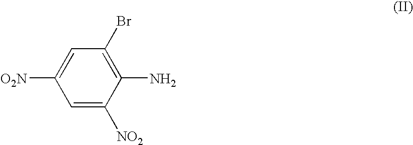

is coupled with a compound of the formula (III)

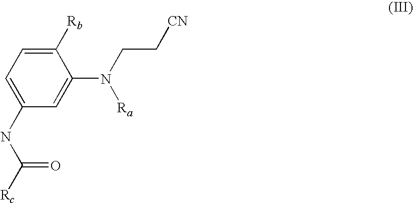

and in a further step the Br substituent in the diazo component is replaced by —CN.

Diazotization and coupling are carried out according to commonly known methods. The replacement of the Br substituent in the diazo component by —CN can be effected by means of a Cu(I)-dimethyl sulfoxide complex reagent or by other exchange methods known from the literature and to one skilled in the art.

The compounds of the formulae II and III are known or are readily preparable from known compounds by methods known to one skilled in the art.

The invention also provides dye mixtures comprising at least one dye of the formula (I) and a further disperse dye.

A dye mixture now found comprises at least one dye of the formula (I) and at least one dye of the formula (II)

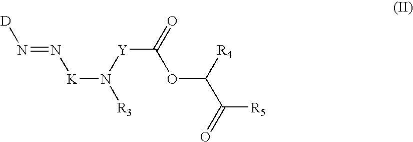

where
D is a diazo component derived from a substituted or unsubstituted aromatic amine,
K is an aromatic radical of the formula K₁, K₂ or K₃

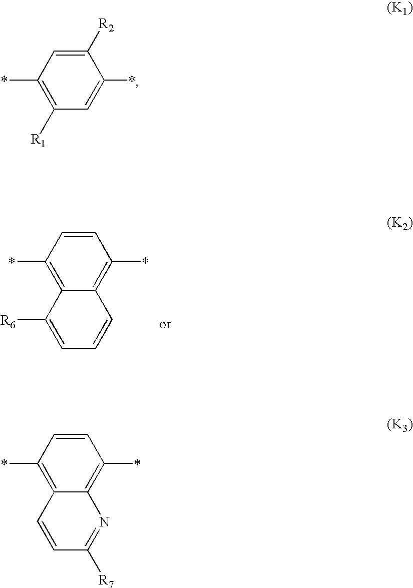

R₁ is hydrogen, chlorine, C₁₋₂-alkyl, C₁₋₂-alkoxy, hydroxyl or acylamino,
R₂ is hydrogen, C₁₋₄-alkoxy, C₁₋₂-alkoxyethoxy, chlorine, bromine or together with
R₃ a group of the formula -*CH(CH₃)CH₂C(CH₃)₂— (* attached to the nucleus),
R₃ is hydrogen, C₁₋₆-alkyl, C₃₋₄-alkenyl, chloro- or bromo-C₃₋₄-alkenyl, C₃₋₄-alkynyl, phenyl-C₁₋₃-alkyl, C₁₋₄-alkoxycarbonyl-C₁₋₃-alkyl, C₃₋₄-alkenyloxycarbonyl-C₁₋₃-alkyl, C₃₋₄-alkynyloxycarbonyl-C₁₋₃-alkyl, phenoxy-C₂₋₄-alkyl, halo-, cyano-, C₁₋₄-alkoxy-, C₁₋₄-alkylcarbonyloxy- or C₁₋₄-alkoxycarbonyloxy-substituted C₂₋₄-alkyl or a group of the formula —CH₂—CH(R₈)CH₂—R₉,
R₄ is hydrogen or C₁₋₂-alkyl,
R₅ is phenyl, a phenyl which may be substituted by one or two substituents selected from the group consisting of methyl, chlorine, bromine and nitro, or combines with R₄ to form a c-pentanone or c-hexanone ring,
R₆ is hydrogen or hydroxyl,
R₇ is hydrogen or methyl,
R₈ is hydroxyl or C₁₋₄-alkylcarbonyloxy,
R₉ is chlorine, C₁₋₄-alkoxy, phenoxy, allyloxy or C₁₋₄-alkylcarbonyloxy,
Y is C₁₋₃-alkylene,
   subject to the proviso that when K is a radical of the formula K₂ or K₃ R₃ has no meaning other than hydrogen.

A group of preferred dyes of the formula I conform to the general formula (IIa)

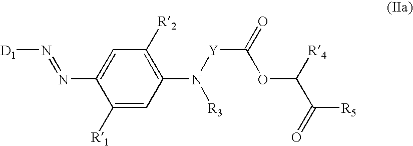

where
D₁ is 3-phenyl-1,2,4-thiadiazolyl or conforms to one of the following formulae:

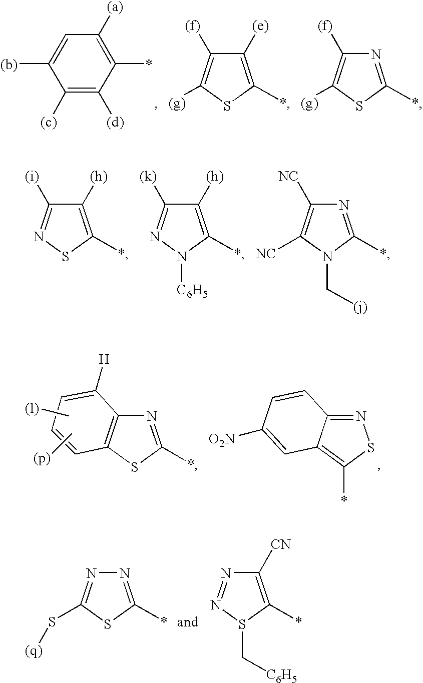

where
(a) is hydrogen, chlorine, bromine, cyano, nitro-, C₁₋₄-alkoxycarbonyl, C₁₋₃-alkyl-sulphonyl, preferably hydrogen, chlorine, cyano or nitro,
(b) is chlorine, bromine, nitro, methyl, C₁₋₂-alkylsulphonyl, C₁₋₄-alkylcarbonyl, aminosulphonyl, mono- or di-C₁₋₄-alkylaminosulphonyl, phenylaminosulphonyl, C₁₋₄-alkoxycarbonyl, benzyloxycarbonyl, tetrahydrofurfuryl-2-oxycarbonyl, C₃₋₄-alkenyloxycarbonyl, C₃₋₄-alkynyloxycarbonyl, aminocarbonyl, mono- or di-C₁₋₄-alkylaminocarbonyl, phenylaminocarbonyl or phenylazo,
(c) is hydrogen or chlorine or else when (d) is hydrogen hydroxyl or rhodan,
(d) is hydrogen, chlorine, bromine, hydroxyl or cyano,
(e) is nitro, C₁₋₄-alkylcarbonyl, C₁₋₄-alkoxycarbonyl, cyano, aminocarbonyl, mono- or di-C₁₋₄-alkylaminocarbonyl,
(f) is hydrogen, chlorine, bromine, C₁₋₂-alkyl or phenyl,
(g) is nitro, cyano, formyl, dicyanovinyl or a group of the formula —CH═CH—NO₂, —CH═C(CN)CO—OC₁₋₄-alkyl, H₅C₆—N═N— or 3- or 4-NO₂—C₆H₄—N═N—,
(h) is cyano or C₁₋₄-alkoxycarbonyl,
(i) is C₁₋₄-alkyl or phenyl,
(j) is —CN, —CH═CH₂ or phenyl,
(k) is C₁₋₄-alkyl,
(l) is hydrogen, chlorine, bromine, cyano, rhodan, nitro, C₁₋₄-alkoxycarbonyl or di-C₁₋₄-alkylaminosulphonyl,
(p) is hydrogen, chlorine or bromine, and
(q) is C₁₋₄-alkyl or C₁₋₄-alkoxycarbonyl-C₁₋₄-alkyl,
   wherein the phenyl nuclei of these substituents may bear one or two substituents selected from the group consisting of chlorine, bromine, methyl and C₁₋₂-alkoxy,
R′₁, is hydrogen, methyl, chlorine or acylamino,
R′₂ is hydrogen, chlorine, C₁₋₂-alkoxy, C₁₋₂-alkoxyethoxy or combines with R₃ to form a group of the formula —CH(CH₃)CH₂C(CH₃)₂—,
R₃ and R₅ are each as defined above,
R′₄ is hydrogen or methyl, and
Y is a group of the formula —CH₂CH₂— or —CH₂CH(CH₃)—.

Particular preference is given to disperse dyes of the formula (IIb)

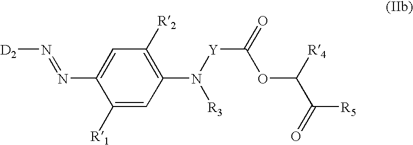

where
D₂ is the residue of a diazo component of the formula 2,6-dicyano-4-chloro-, 2,6-dicyano-4-bromo-, 2,6-dicyano-4-methyl-, 2,6-dicyano-4-nitrophenyl, 2,4-dinitro-6-chloro-, 2,4-dinitro-6-bromo- or 2,4-dinitro-6-cyanophenyl, 2-chloro-4-nitro-6-cyanophenyl, 2-bromo-4-nitro-6-cyanophenyl, 2,4-dinitrophenyl, 2,6-dichloro-4-nitrophenyl, 2,6-dibromo-4-nitrophenyl, 2-chloro-4-nitro-6-bromophenyl, 2-chloro-4-nitrophenyl, 2-cyano-4-nitrophenyl, 2,4-dinitro-5,6-dichlorophenyl, 2,5-dichloro-4-nitrophenyl, 4-nitrophenyl, 4-phenylazophenyl, 4-C₁₋₄-alkoxycarbonylphenyl, 2-C₁₋₄-alkoxy-carbonyl-4-nitrophenyl, 4-benzyloxycarbonylphenyl, 4-(tetrahydrofurfuryl-2′-oxycarbonyl)phenyl, 3,5-dicyano-4-chloro-thienyl-2,3,5-dicyano-thienyl-2,3-cyano-5-nitro-thienyl-2,3-acetyl-5-nitro-thienyl-2,3,5-dinitro-thienyl-2,3-(C₁₋₄-alkoxycarbonyl)-5-nitro-thienyl-2,5-phenylazo-3-cyano-thienyl-2,5-phenylazo-3-cyano-4-methyl-thienyl-2,5-nitro-thiazolyl-2,5-nitrobenziso-thiazolyl-3,3-methyl-4-cyano-isothiazolyl-5,3-phenyl-1,2,4-thiadiazolyl-2,5-(C₁₋₂-alkylmercapto)-1,3,4-thiadiazolyl-2,3-(C₁₋₂-alkoxycarbonylmethyl-mercapto)-1,2,4-thiadiazolyl-5,1-cyanomethyl-4,5-dicyano-imidazolyl-2,6-nitrobenzothiazolyl-2,5-nitrobenzothiazolyl-2,6-rhodanbenzothiazolyl-2,6-chlorobenzthiazolyl-2, (5),6,(7)-dichlorobenzothiazolyl-2, or of the formula

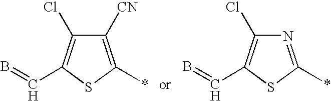

and B is oxygen or a group of the formula ═(CN)₂, ═CH—NO₂, ═(CN)—COOC₁₋₄alkyl or ═(CN)—COOC₃₋₄alkenyl
   and the symbols R′₁, R′₂, R₃, R′₄, R₅ and Y are each as defined above.

Particular preference is further given to the disperse dyes of the formula II where
D is a diazo component selected from the group consisting of 2,4-dinitro-6-chloro-phenyl, 2,4-dinitro-6-bromophenyl, 2,4-dinitro-6-cyanophenyl or 2,6-dicyano-4-nitrophenyl,
K is a radical of the formula Kᵢ,
R₁ is C₁₋₂-alkylcarbonylamino with or without bromine, chlorine, hydroxyl or C₁₋₂-alkoxy substitution; phenylaminocarbonyl, methylsulphonylamino, methyl or hydrogen,
R₂ is C₁₋₂-alkoxy or hydrogen,
R₃ is hydrogen, C₁₋₄-alkyl, cyanoethyl, C₁₋₂-alkoxyethyl or C₃₋₄-alkenyl
R₄ is hydrogen,
R₅ is phenyl, and
Y is a group of the formula —CH₂CH₂—.

Useful diazo components include all mono- to binuclear carbo- or heterocyclic organic radicals or residues of aromatic character which can bear customary disperse dye substituents except in particular water-solubilizing substituents, i.e. sulphonic acid groups especially. Useful diazo components further include residues of monoazo compounds. Examples of diazo components are: preferably substituted phenyl, thienyl, thiazolyl, isothiazolyl, thiadiazolyl, pyrazolyl, imidazolyl, triazolyl, benzothiazolyl or benzisothiazolyl radicals.

All the alkyl groups mentioned contain, unless otherwise stated, 1 to 8 and especially 1 to 4 carbon atoms, they can be straight-chain or branched and may be substituted, for example by halogen atoms, preferably bromine or chlorine atoms, hydroxyl, alkoxy, phenyl, phenoxy, cyano, rhodan, acyl, acyloxy or acylamino groups.

The Y interlink is preferably a group of the formula —CH₂CH₂— or —CH₂CH(CH₃)— especially —CH₂CH₂—.

All alkyl, alkylene and alkenyl radicals are straight chain, unless stated otherwise.

The process for preparing the dyes of the formula (II) is characterized in that a diazotized amine of the formula (A-II)

D—NH₂ (A-II)

is coupled with a compound of the formula (B-II)

H—K (B-II).

Diazotizing and coupling are carried out according to commonly known methods.

The compounds of the formulae A-II and B-II are known or are easy to prepare from known compounds by methods known to one skilled in the art.

We have further found a dye mixture comprising at least one dye of the formula (I) and at least one dye of the formula (III) which conforms to the dye of the formula (II) where R₅ corresponds to the —O—R₆ substituent where R₆ is phenyl or a phenyl which may be substituted by one or two substituents selected from the group consisting of methyl, chlorine, bromine and a nitro group or combines with R₄ to form a c-pentanone or c-hexanone ring.

The dyes of the formula (III) are known for example from GB2271573 or from DE4335261.

We have further found a dye mixture comprising at least one dye of the formula (I) and at least one dye of the formula (IV)

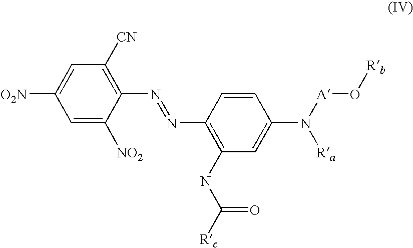

where
R′ₐ is C₁-C₄-alkyl or a group of the formula -A′-O—R′_{b},
R′_{b} is phenyl or naphthyl or C₁-C₄-alkyl- or halogen-substituted phenyl or C₁-C₄-alkyl- or halogen-substituted naphthyl,
R′_{c} is C₁-C₄-alkyl or phenyl or C₁-C₄-alkyl- or halogen-substituted C₁-C₄-alkyl or phenyl, and
A′ is C₁-C₄-alkyl.

Preferably
R′ₐ is C₁-C₄-alkyl,
R′_{b} is phenyl or naphthyl or methyl-, ethyl- or halogen-substituted phenyl or methyl-, ethyl- or halogen-substituted naphthyl,
R′_{c} is methyl or ethyl or phenyl or methyl-, ethyl- or halogen-substituted methyl or ethyl or phenyl, and
A′ is ethylene.

The dyes of the formula (IV) are known for example from GB1395022.

We have further found a dye mixture comprising at least one dye of the formula (I) and at least one dye of the formula (V)

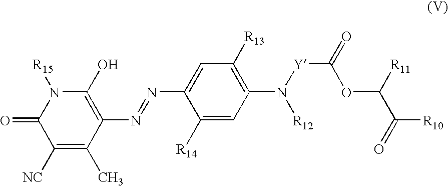

where
Y′ is C₁₋₃-alkylene,
R₁₀ is phenyl or methyl-, ethyl- or halogen-substituted phenyl,
R₁₁ is H or C₁-C₄-alkyl or C₁-C₄-alkoxy,
R₁₂ is H or C₁-C₄-alkyl or C₁-C₄-alkoxy,
R₁₃ is H or C₁-C₄-alkyl or C₁-C₄-alkoxy, and
R₁₄ is C₁-C₄-alkyl
R₁₁ and R₁₂ and R₁₃ are independently preferably H. R₁₄ is preferably n-butyl. Y′ is preferably ethylene.

The dyes of the formula (V) are known for example from GB2300863 or DE19618586.

We have further found a dye mixture comprising at least one dye of the formula (I) and at least one dye of the formula (VI)

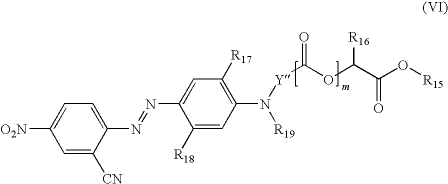

where

### R₁₅ is

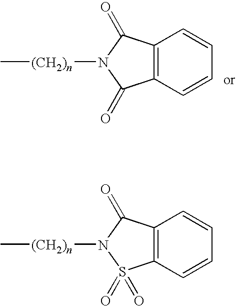

R₁₆ is H or C₁-C₄-alkyl or C₁-C₄-alkoxy,
R₁₇ is H or C₁-C₄-alkyl or C₁-C₄-alkoxy or bromine or chlorine,
R₁₈ is H or C₁-C₄-alkyl or C₁-C₄-alkoxy or bromine or chlorine,
Y″ is C₁-C₄-alkylene,
n is 1 or 2 or 3 or 4, and
m is 0 or 1.

In preferred compounds of the formula (VI) n=2. In preferred compounds R₁₆ is H or C₁-C₄-alkyl and most preferably R₁₆ is H, and R₁₆ and R₁₇ are independently H or C₁-C₄-alkyl or bromine or chlorine, most preferably R₁₆ and R₁₇ are independently H, or bromine or chlorine. Y″ is preferably an ethylene group.

The dyes of the formula (VI) are known for example from GB2287035 or DE 19500228.

Preferably halogen is chlorine or bromine and most preferably halogen is a chlorine substituent.

The invention further provides dye mixtures comprising at least one dye of the formula (I) and additionally a dye of the formula (II) and/or dyes of the formula (III) and/or dyes of the formula (III) and/or dyes of the formula (IV) and/or dyes of the formula (V) and/or dyes of the formula (VI). Further dyes may be present in the mixtures of the invention, if appropriate.

The invention further provides dye mixtures comprising at least one dye of the formula (I) and at least one dye of the formula (II) and at least one of the dyes of the formula (III) and additionally dyes of the formula (III) and/or dyes of the formula (IV) and/or dyes of the formula (V) and/or dyes of the formula (VI). Further dyes may be present in the mixtures of the invention, if appropriate.

Preferably, the dye mixture of the invention comprises 1% to 99% and more preferably 1% to 80% by weight, in particular 5% to 60% by weight of at least one dye of the formula (I) and 1% to 99% and more preferably 5% to 60% by weight, in particular 5% to 40% by weight of at least one dye of the formula (II), (III), (IV), (V) or (VI) based on the total amount of dye, subject to the proviso that the sum total of the dye fractions shall be 100%.

The dye mixtures of the invention lead in particular in the above-indicated mixing ratios to navy shades which are notable for good to very good exhaustion and high light fastness.

The mixtures of the invention are notable in particular for excellent sublimation fastness and good exhaustion. The polyester-elastane blend fabrics dyed with the mixtures of the invention are notable in particular for excellent wash fastness. The polyester-elastane blend fabrics dyed with the mixtures of the invention do not stain adjacent nylon fabric, in particular nylon 6.6, or acetate. Nor do the polyester-elastane blend fabrics dyed with the mixtures of the invention acquire a yellow tinge after repeated washing. The substrates dyed with the mixtures of the invention exhibit excellent fastness under the conditions of the ISO 105/C06 wash at 50° C. and also when subjected to the ISO 105/C06 wash at 60° C. The mixtures of the invention are notable for high build-up capacity, which leads to very deep dark shades, in particular to a deeper black.

The dye mixture of the invention may also comprise further disperse dyes.

The invention further provides a process for preparing the mixture of the invention, characterized in that the individual dyes (I) combined with (II) and/or (III) and/or (III) and/or (IV) and/or (V) and/or (VI) and if appropriate further dyes of the dye mixture are ground in water in the presence of a dispersant, subsequently mixed and if appropriate dried, or in that the dyes (I) are mixed with (II) and/or (III) and/or (III) and/or (IV) and/or (V) and/or (VI) and if appropriate further dyes, ground in water in the presence of a dispersant and if appropriate dried.

Dye mixtures according to the invention which are composed of the dyes of the formulae (I) with (II) and/or (III) and/or (III) and/or (IV) and/or (V) and/or (VI) and also if appropriate one or more further dyes are preparable by simply mixing the components. The mixing can be effected by mixing separately finished individual components in the dyeing liquor, or else, preferably, by the presscakes of the individual components being mixed and conjointly finished.

The finish is characterized in that the dyes are converted by a grinding operation in the presence of a dispersant into an aqueous dispersion, i.e. into a liquid dye formulation or, after drying, into a pulverulent dye formulation, for which the individual dyes can first be separately finished and then mixed or the individual dyes first mixed and then conjointly finished. This grinding is preferably accomplished in mills, such as for example ball, swing, bead or sand mills, or in kneaders. After grinding, the size of the dye particles is preferably about 0.1 to 10 micrometers, in particular about 1 micrometer. The grinding is preferably effected in the presence of dispersants, which can be nonionic or anion active. Nonionic dispersants are for example reaction products of alkylene oxides, such as for example ethylene oxide or propylene oxide with alkylatable compounds, such as for example fatty alcohols, fatty amines, fatty acids, phenols, alkylphenols and carboxamides. Anion-active dispersants are for example ligninsulphonates and salts thereof, alkyl- or alkylarylsulphonates, alkylaryl polyglycol ether sulphates, alkali metal salts of the condensation products of naphthalenesulphonic acids and formaldehyde, polyvinylsulphonates and ethoxylated novolacs.

The invention accordingly also provides dye formulations comprising

10% to 60% by weight of the dye mixture of the invention, and
40% to 90% by weight of dispersant.

The dye formulations can be present in liquid or solid form, in which case the liquid formulations are preferably aqueous dye dispersions and the solid formulations are present as a powder or granules.

Preferred aqueous dye formulations comprise water,

15% to 50% by weight of the dye mixture of the invention, and
10% to 25% by weight of dispersant, all based on the dye formulation.

The abovementioned nonionic and anionic dispersants are preferred dispersants.

The dye formulations of the present invention may also comprise further auxiliaries, for example those which act as oxidizing agents, such as for example sodium m-nitrobenzenesulphonate, or fungicidal agents, such as for example sodium o-phenylphenoxide and sodium pentachlorophenoxide. Wetting agents, antifreeze agents, dustproofing agents or hydrophilicizing agents may also be present.

There are certain application sectors where solid formulations such as pulverulent or granular brands are preferred. Preferred solid dye formulations comprise

30% to 50% by weight of the dye mixture of the invention, and
70% to 50% by weight of dispersant.

They may further comprise if appropriate auxiliaries, such as for example wetting, oxidizing, preserving and dustproofing agents.

A preferred process for producing solid dye formulations consists in the above-described liquid dye formulations being stripped of their liquid, for example by vacuum drying, freeze drying, by drying on drum dryers, but preferably by spray drying.

Dye mixtures of the invention, however, are preferably also producible by conjoint finishing of the mixing components.

To this end, the mixing components are dispersed in water by a grinding operation in a suitable mixing ratio as described above and if appropriate converted into a solid dye formulation by removing the water.

To improve the properties of the dye formulations, it can be advantageous to subject the mixing components to a heat treatment before grinding. The heat treatment is carried out at 25 to 98° C., preferably at 30 to 80° C. and more preferably at 40 to 60° C. It is advantageous to follow the heat treatment directly, without intervening isolation, by a finishing operation, i.e. conversion into the commercial solid or liquid formulations. For this purpose, the heat-treated suspension is converted into a dispersion by grinding. It is advantageous for the heat treatment to be carried out in the presence of those dispersing and also, if appropriate, auxiliary agents which are to be present in the finished solid or liquid formulation. These are identical to the abovementioned surface-active substances. If the total amount of these dispersing and auxiliary agents was not added during the heat treatment, then the remainder is added prior to grinding. In this case, the amount of surface-active substances added for the heat treatment is generally in the range from 10% to 400% by weight and preferably in the range from 20% to 200% by weight, based on the dye mixtures.

To prepare the dyeing liquors, the requisite amounts of the dye formulations which were prepared in accordance with the above directions are diluted with the dyeing medium, preferably with water, to such an extent that a liquor ratio in the range from 5:1 to 50:1 results for the dye. In addition, further dyeing auxiliaries, such as carriers, dispersing and wetting agents are generally added to the liquors.

If the dye mixture of the invention is to be used for textile printing, then the requisite amounts of the dye formulation are preferably kneaded together with thickeners, such as for example alkali metal alginates or the like, and if appropriate further additives, such as for example fixation accelerants, wetting agents and hydrating agents to form printing pastes.

The dye mixtures of the invention, which may incidentally comprise still further dyes, are exceedingly suitable for dyeing and printing hydrophobic synthetic materials. Useful hydrophobic synthetic materials include for example: cellulose triacetate and high molecular weight polyesters. Preferably, the dye mixtures of the invention are used for dyeing and printing materials composed of high molecular weight polyesters, in particular those based on polyethylene glycol terephthalates or their blends with natural fibre materials, such as in particular wool or cellulose, or materials composed of cellulose triacetate. The dye mixtures of the invention are very particularly suitable for dyeing and/or printing polyester-polyurethane union fabrics and polyester-polyurethane blend fibre fabrics.

The hydrophobic synthetic materials can be present in the form of sheet- or threadlike structures and have been processed for example into yarns or woven, loop-formingly knitted or loop-drawingly knitted textile materials. The dyeing of the fibre material mentioned with the dye mixtures of the invention can be effected in a conventional manner, preferably from an aqueous dispersion, if appropriate in the presence of carriers, between 80 to about 110° C. by the exhaust process or by the HT process in a dyeing autoclave at 110 to 140° C., and also by the so-called thermofixing process in which the fabric is padded with the dyeing liquor and then fixed/set at about 180 to 230° C. The printing of the materials mentioned can be carried out in a conventional manner by incorporating the dye mixtures of the invention into a printing paste and treating the fabric printed therewith HT steam or dry heat at temperatures between 180 to 230° C., if appropriate in the presence of a carrier, to fix the dyes. This provides very strong olive, navy or black, in particular strong navy or black, dyeings and prints having very good fastnesses, in particular having very good light, rub, thermofixing, wash, water and sublimation fastnesses. The customary dyeing processes with which the dye mixtures of the invention can be dyed and/or printed are described for example in M. Peter and H. K. Rouette: “Grundlagen der Textilveredelung; Handbuch der Technologie, Verfahren und Maschinen”, thirteenth, revised edition, 1989, Deutscher Fachverlag GmbH, Frankfurt am Main, Germany, ISBN 3-87150-277-4, in which the following pages are particularly relevant: the pages 460-461, 482-495, 556-566 and 574-587.

The dye mixtures of the invention exhibit excellent wetting characteristics when making up dyeing and padding liquors and also printing pastes, and are rapidly dispersible without costly and inconvenient manual or mechanical stirring. The liquors and printing pastes are homogeneous and are easy to process in state of the art dyehouse drugstores without plugging the nozzles.

The liquid formulations of the invention have no tendency to phase separate and in particular no tendency to sediment and form a sticky deposit. There is thus no need for a similarly costly and inconvenient homogenization of the dye in the container prior to dye removal.

The millbase obtained in the production of solid formulations after grinding of the dyes in the presence of dispersing and auxiliary agents is stable at elevated temperature and for a prolonged period. The millbase does not need to be cooled in the mills or after removal from the mills and can be stored in collecting vessels for a prolonged period prior to spray drying.

The thermal stability of the dye mixture of the invention is also apparent from the fact that the spray-drying operation can be carried out at high temperatures without the material which is to be dried undergoing agglomeration. For a given dryer exit temperature, a higher entry temperature results in higher dryer performance and thus in lower manufacturing costs.

The dye formulations described above are very advantageously useful for making up printing pastes and dye liquors. They offer particular advantages for example in relation to the continuous processes where the dye concentration of the dyeing liquors has to be kept constant by continuously feeding dye into the running apparatus.

The advantage of the dye mixtures of the invention is particularly distinct when dyeing from an aqueous dyebath under state of the art commercial conditions.

State of the art commercial conditions are characterized by high pack densities in package and beam dyeings, short liquor ratios, i.e. high dye concentrations, and also high shearing forces in the dyeing liquor due to high pumping power. Even under these conditions, the dye mixtures of the invention do not tend to agglomerate, and do not filter out on the textile materials to be dyed. The dyeings obtained are accordingly homogeneous and have no colour strength differences between the outer and the inner coils of the wound packages, and the dyeings are free of any deposits. Pad dyeings and prints with the dye mixture of the invention produce a homogeneous, speckle-free appearance.

The dye mixtures of the invention are also useful for dyeing the above-recited hydrophobic materials from organic solvents by known solvent-dyeing methods and for mass coloration.

The invention therefore also provides for the use of the dye mixtures of the invention for dyeing and printing hydrophobic synthetic materials, in particular fibre materials and also for mass coloration of hydrophobic synthetic materials.

The examples which follow illustrate the invention. Parts and % in the description, examples and claims are by weight, unless otherwise stated.

### EXAMPLES

### Example (I)-1

### Diazotization

A suitable reaction vessel is charged with 112.3 g of 100 percent sulphuric acid, 5.7 g of ice and gradually with 52.4 g of 1-amino-2-bromo-4,6-dinitroaniline in such a way that the temperature does not rise above 40° C. (this takes about 20 min). This suspension was stirred overnight and the next morning 65.5 g of nitrosylsulphuric acid (40%) were added at 40-45° C. within 30 minutes and the mixture was then left to stir for a further hour.

### Coupling

A 2 litre glass beaker equipped with stirrer is charged with a solution of 64.7 g of 3-(N-benzyl-N-cyanoethylamino)-4-methoxy-1-acetanilide in 64.7 g of 1:1 ethanol/acetic acid and this initial charge was admixed with 1.0 g of aminosulphonic acid, 1.6 g of Surfynol 104E (2,4,7,9-tetramethyl-5-decyne-4,7-diol) and 100 g of ice at a temperature between −10° and −5° C. by stirring.

The diazonium salt solution from the first part was then added dropwise within 60 minutes with thorough stirring and with portionwise addition of 400 g of ice such that the temperature remains at between −5° and 0° C.

The temperature was gradually allowed to rise to about 15° C. on complete addition of the diazonium salt solution.

The product formed is filtered off and washed with water until the wash liquor is sulphate free.

The following dye is obtained as intermediate (ZP):

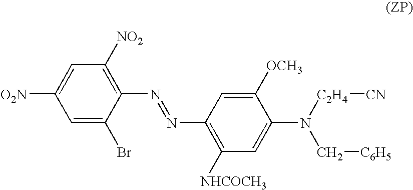

### Cyanation

220 g of DMSO (dimethyl sulphoxide) is transferred into the reactor vessel under nitrogen in a suitable reactor vessel and heated to about 75° C. 2.45 g of sodium cyanide (NaCN) are added with stirring before stirring for 15 minutes until a solution is formed. Then 4.48 g of copper(I) cyanide (Cu(I)CN) are added; the temperature rises to about 80° C. in the process.

1 g of a 1M phosphate buffer solution is added to this solution; thereafter, 54.25 g of the intermediate (ZP) are gradually added at 90° C. over 90 minutes with thorough stirring and the temperature is maintained at 90° C. for a further 1 to 2 hours. Thereafter, 1.4 g of 50% sulphuric acid are added; the temperature of the reaction mixture is allowed to decrease to about 60° C. in the process.

The suspension is then filtered off and the filter residue is washed with 33.0 g of DMSO and 6.0 g of water.

The filtercake is introduced into a mixture of 200 g of hot water at 55° C. and 0.81 g of iron(III) chloride. This suspension is very thoroughly stirred at 65° C. for two hours, then filtered off and washed with water.

This gives 41.1 g (85%) of the dye of the formula (1)

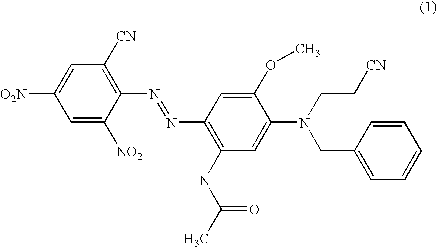

The dye obtained is blue and has a lambda max (measured in DMF) (=λₘₐₓ (DMF)) of 627 nm.

Table 1 below lists further dyes of the general formula (I); they are prepared similarly to Example 1.

TABLE 1
Compounds of formula (I)

| | |
|---|---|
| | (I) |
| 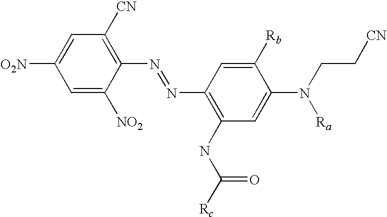 | |

| | | | | lambda max |
|---|---|---|---|---|
| | | | | (measured |
| | | | | in DMF) |
| Exam- | | | | (=λₘₐₓ |
| ple | Rₐ | R_{b} | R_{c} | (DMF)) |
| (I)-2 | —CH₂CH₂—C₆H₅ | —OCH₃ | —CH₃ | 628 |
| (I)-3 | —CH₂CH₂—C₆H₅ | —OCH₂CH₃ | —CH₃ | 630 |
| (I)-4 | —CH₂—C₆H₅ | —OCH₃ | —CH₂CH₃ | 625 |
| (I)-5 | —CH₂—C₆H₅ | —OCH₂CH₃ | —CH₂CH₃ | 632 |

### Example 1

16.3 parts of 2-cyano-4-nitroaniline are suspended in 100 parts of cold sulphuric acid 93% and admixed with 32 parts of nitrosylsulphuric acid (40%) at 0-5° C. in the course of 30 minutes. This is followed by 3-4 hours of stirring at 0-5° C., and then the resulting diazonium salt solution is poured continuously with stirring into a mixture of 29.7 parts of phenylcarbonylmethyl 3-(N-methyl-N-phenylamino)-propionate, 100 parts of glacial acetic acid, 2 parts of sulphamic acid, 200 parts of water and 300 parts of ice. The precipitated dye is filtered off, washed acid free with water and dried at 60° C. under reduced pressure. The dye obtained conforms to the formula

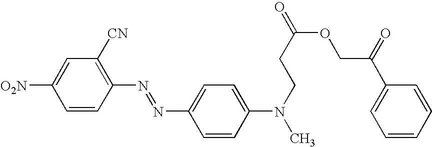

It dyes polyester fibre material in ruby shades having excellent fastnesses, especially very good wet fastnesses after thermal stabilization, and is very useful, alone or in mixtures, for state of the art rapid-dyeing processes such as for example the ®Foron RD process. λₘₐₓ=530 nm (DMF)

### Example 2

26.2 parts of 2-bromo-4,6-dinitroaniline are suspended in 150 parts of sulphuric acid 93% at 15-20° C. and admixed with 32 parts of nitrosylsulphuric acid 40% in the course of 30 minutes. This is followed by 2-3 hours of stirring, and the diazonium salt solution is poured continuously with stirring into a mixture of 36.8 parts of phenylcarbonylmethyl 3-(N-ethyl-N-(3′-acetylamino-phenylamino))-propionate, 100 parts of glacial acetic acid, 2 parts of sulphamic acid, 100 parts of water and 200 parts of ice. The precipitated dye is filtered off, washed acid free with water and dried at 60° C. under reduced pressure. The dye obtained conforms to the formula

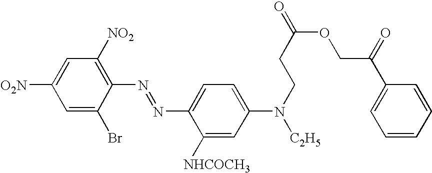

and dyes polyester fibre material in violet shades having excellent fastnesses. The dye, which has λₘₐₓ=559 (DMF), is very useful, alone or in navy or black mixtures, for state of the art rapid-dyeing processes such as for example the ®Foron RD process.

### Example 3

64.1 parts of 2-bromo-4,6-dinitroaniline-1-azo dye (preparation according to Example 2), 1 part of potassium iodide are suspended in 200 parts of dimethyl sulphoxide at 60° C., admixed with 9.8 parts of copper(I) cyanide and stirred for 2-3 hours. The reaction product is filtered off at about 50° C., washed with 50 parts of 1:1 DMSO/water in portions and dried at 60° C. under reduced pressure. The dye obtained conforms to the formula

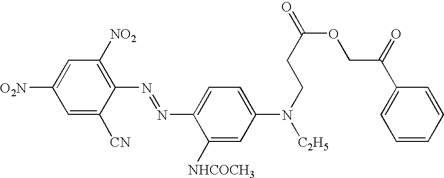

and dyes polyester fibre material in blue shades having excellent fastnesses, especially having excellent wet fastnesses. The dye, which has λₘₐₓ=604 (DMF), is, alone or in mixtures, very useful for state of the art rapid-dyeing processes such as for example the ®Foron RD process.

### Example 4

16.3 parts of 2-amino-4-chloro-5-formylthiazole are dissolved in 100 parts of sulphuric acid 93% and admixed with 32 parts of nitrosylsulphuric acid 40% at 0 to 5° C. in the course of 30 minutes. This is followed by 3 hours of stirring in an icebath, and the diazonium salt solution is poured continuously into a mixture of 41.0 parts of phenylcarbonylmethyl 3-[N-allyl-N-(5′-acetylamino-2′-methoxy-phenylamino)]-propionate, 100 parts of glacial acetic acid, 2 parts of sulphamic acid and 300 parts of ice/water. The precipitated dye is filtered off, washed acid free with water and dried at 60° C. under reduced pressure. The dye obtained, which has λₘₐₓ=625 (DMF), conforms to the formula

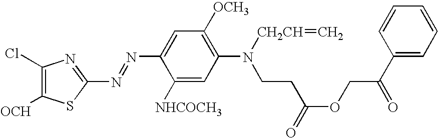

and dyes polyester materials in greenish navy shades and is useful as individual dye or in navy and black mixtures for the ®Foron RD rapid-dyeing process, with very good fastnesses.

### Example 5

18.6 parts of 2-amino-4-chloro-3-cyano-5-formylthiophene are dissolved in 200 parts of cold sulphuric acid 85%. 32 parts of nitrosylsulphuric acid 40% are added dropwise with stirring at 0 to 5° C. in the course of 30 minutes. This is followed by 3 hours of stirring in an icebath, and the diazonium salt solution is poured continuously into a mixture of 32.5 parts of phenylcarbonylmethyl 3-[N-ethyl-N-(3′-methylphenylamino)]-propionate, 50 parts of 5% sulphuric acid, 2 parts of sulphamic acid and 300 parts of ice. The precipitated dye is filtered off, washed acid free with water and dried at 60° C. under reduced pressure. The dye obtained having λₘₐₓ=610 (DMF), conforms to the formula

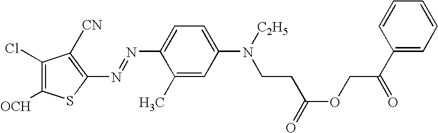

and dyes polyester materials in brilliant reddish blue shades having good fastnesses.

Table 2 below indicates further dyes of the general formula (IIc); they are prepared similarly to Examples (II)-1 to (II)-5.

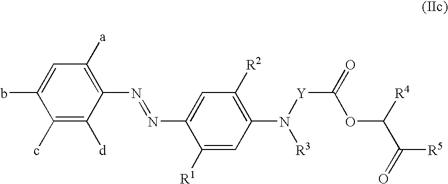

TABLE 2
(Dyes of the general formula (IIc))

| | |
|---|---|
| | (IIc) |
| 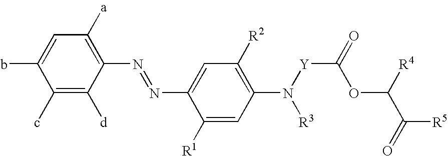 | |

| | | | | | | | | | | | λₘₐₓ |
|---|---|---|---|---|---|---|---|---|---|---|---|
| Ex. | (a) | (b) | (c) | (d) | Y | R¹ | R² | R³ | R⁴ | R⁵ | (DMF) |
| 6 | NO₂ | NO₂ | H | Br | —C₂H_{4—} | NHCOCH₃ | H | n-C₃H₇ | H | C₆H₅ | 560 |
| 7 | NO₂ | NO₂ | H | CN | —C₂H_{4—} | NHCOCH₃ | H | n-C₃H₇ | H | C₆H₅ | 611 |
| 8 | NO₂ | NO₂ | H | CN | —C₂H_{4—} | NHCOC₂H₅ | H | C₂H₅ | H | C₆H₅ | 612 |
| 9 | NO₂ | NO₂ | H | CN | —C₂H_{4—} | NHCOCH₃ | H | CH₂CH═CH₂ | H | C₆H₅ | 608 |
| 10 | NO₂ | NO₂ | H | CN | —C₂H_{4—} | NHCOCH₃ | H | C₂H₄OCH₃ | H | C₆H₅ | 609 |
| 11 | NO₂ | NO₂ | H | CN | —C₂H_{4—} | NHCOCH₃ | H | CH₂CHOHCH₂Cl | CH₃ | C₆H₅ | 608 |
| 12 | NO₂ | NO₂ | H | CN | —C₂H_{4—} | NHCOCH₂Cl | H | C₂H₅ | H | C₆H₅ | 605 |
| 13 | NO₂ | NO₂ | H | CN | —C₂H_{4—} | NHCOCH₂CH₂Cl | H | C₂H₅ | H | C₆H₅ | 607 |
| 14 | CN | NO₂ | H | CN | —C₂H₄— | NHCOCH₃ | H | n-C₄H₉ | H | CH₃ | 615 |
| 15 | CN | NO₂ | H | CN | —C₂H₄— | NHCOCH₃ | H | n-C₃H₇ | H | C₂H₅ | 614 |
| 16 | CN | NO₂ | H | CN | —C₂H₄— | NHCOCH₃ | H | C₂H₅ | H | C₆H₅ | 613 |
| 17 | NO₂ | NO₂ | H | CN | —C₂H₄— | NHCOCH₃ | H | CH₃ | H | C₆H₅ | 610 |
| 18 | NO₂ | NO₂ | H | CN | —C₂H₄— | NHCOCH₃ | H | CH₂C(CH₃)H═CH₂ | H | C₆H₅ | 612 |
| 19 | NO₂ | NO₂ | H | Cl | —C₂H₄— | NHCOCH₂OCH₃ | OC₂H₅ | H | H | C₆H₅ | 596 |
| 20 | NO₂ | NO₂ | H | Cl | —C₂H₄— | NHCOCH₂Cl | OCH₃ | H | H | C₆H₅ | 594 |
| 21 | NO₂ | NO₂ | H | Cl | —C₂H₄— | NHCOCH═CH₂ | OCH₃ | —C₆H₁₃ | H | C₆H₅ | 608 |
| 22 | NO₂ | NO₂ | H | Cl | —C₂H₄— | NHCHO | OCH₃ | CH₂C₆H₅ | H | C₆H₅ | 602 |
| 23 | NO₂ | NO₂ | H | Cl | —CH₂— | NHCOCH₃ | OCH₃ | H | H | C₆H₅ | 596 |
| 24 | NO₂ | NO₂ | H | Br | —C₂H₄— | NHCOCH₃ | OCH₃ | H | H | C₆H₅ | 597 |
| 25 | NO₂ | NO₂ | H | Br | —C₂H₄— | NHCOCH₃ | OCH₃ | C₂H₄OCOCH₃ | H | C₆H₅ | 591 |
| 26 | NO₂ | NO₂ | H | J | —C₂H₄— | NHCOCH₃ | OCH₃ | C₂H₄OCH₃ | H | C₆H₅ | 594 |
| 27 | NO₂ | NO₂ | H | CN | —C₂H₄— | NHCOCH₃ | H | CH₂CH₂CH₂Cl | H | C₆H₅ | 609 |
| 28 | NO₂ | NO₂ | H | CN | —CHCH₃CH₂— | NHCOCH₃ | H | C₂H₄OC₂H₄OCH₃ | H | C₆H₅ | 608 |
| 29 | NO₂ | NO₂ | H | CN | —C₂H₄— | NHCOCH₃ | H | CH₂CH₂CH₂CH₂OCOCH₃ | H | C₆H₅ | 612 |
| 30 | NO₂ | NO₂ | H | CN | —C₂H₄— | NHCOCH₃ | H | CH₂CH(OCOCH₃)CH₃ | H | C₆H₅ | 601 |
| 31 | CN | NO₂ | H | CN | —C₂H₄— | NHCOCH₃ | H | CH₂C₆H₅ | H | C₆H₅ | 597 |
| 32 | CN | NO₂ | H | CN | —C₂H₄— | NHCOC₂H₅ | H | CH₂C₆H₅ | H | C₆H₅ | 598 |
| 33 | CN | NO₂ | H | CN | —CH₂— | NHCOCH₃ | OCH₃ | CH₂C₆H₅ | H | C₆H₅ | 635 |
| 34 | NO₂ | NO₂ | H | Br | —C₂H₄— | NHCOCH₃ | OCH₃ | CH₂C₆H₅ | H | C₆H₅ | 593 |
| 35 | NO₂ | NO₂ | H | Cl | —C₂H₄— | NHCOCH₃ | OCH₃ | CH₂C₆H₅ | CH₃ | C₆H₅ | 594 |
| 36 | NO₂ | NO₂ | H | Cl | —(CH₂)₃— | NHCOOCH₃ | OCH₃ | C₂H₄OCOCH₃ | H | C₆H₅ | 591 |
| 37 | CN | NO₂ | H | Br | —C₂H₄— | NHCOCH₃ | H | C₂H₅ | H | *—(CH₂)₃— | 584 |
| 38 | CN | NO₂ | H | Br | —C₂H₄— | NHCOC₂H₅ | H | n-C₃H₇ | H | C₆H₅ | 585 |
| 39 | CN | NO₂ | H | Cl | —C₂H₄— | NHCOCH₃ | H | C₂H₅ | H | C₆H₅ | 584 |
| 40 | CN | NO₂ | H | H | —C₂H₄— | NHCOCH₃ | H | C₂H₅ | H | C₆H₅ | 554 |
| 41 | CN | NO₂ | H | H | —CHCH₃CH₂— | NHCOCH₃ | H | C₂H₅ | H | C₆H₅ | 555 |
| 42 | CN | NO₂ | H | H | —C₂H₄— | H | H | CH₂CH═CH₂ | H | C₆H₅ | 532 |
| 43 | CN | NO₂ | H | H | —C₂H₄— | H | H | CH₂C₆H₅ | H | C₆H₅ | 530 |
| 44 | CN | NO₂ | H | H | —C₂H₄— | H | H | C₂H₄OC₆H₅ | H | C₆H₅ | 534 |
| 45 | Cl | NO₂ | H | H | —C₂H₄— | NHCOCH₃ | H | CH₂CH═CH₂ | H | C₆H₅ | 527 |
| 46 | Cl | NO₂ | H | H | —C₂H₄— | NHCOCH₃ | H | CH₂COOC₂H₅ | H | C₆H₅ | 517 |
| 47 | COOCH₃ | NO₂ | H | H | —C₂H₄— | NHCOCH₃ | H | CH₂C₆H₅ | H | C₆H₅ | 528 |
| 48 | Cl | NO₂ | H | H | —C₂H₄— | NHCOCH₃ | H | CH₂C₆H₅ | H | C₆H₅ | 525 |
| 49 | Cl | SO₂CH₃ | H | H | —C₂H₄— | NHCOCH₃ | H | C₂H₅ | H | C₆H₅ | 499 |
| 50 | Cl | NO₂ | H | H | —C₂H₄— | NHCOCH₃ | Cl | H | H | C₆H₅ | 505 |
| 51 | OH | NO₂ | H | H | —C₂H₄— | NHCOCH₂OCH₃ | H | CH₂CH═CH₂ | H | C₆H₅ | 520 |
| 52 | OH | NO₂ | H | H | —C₂H₄— | NHCOCH₃ | H | CH₂C₆H₅ | H | C₆H₅ | 516 |
| 53 | OH | NO₂ | H | H | —C₂H₄— | H | H | C₂H₅ | H | C₆H₅ | 518 |
| 54 | CN | Br | H | CN | —C₂H₄— | OH | H | C₂H₄OCOCH₂COC₆H₅ | H | C₆H₅ | 510 |
| 55 | CN | CH3 | H | CN | —C₂H₄— | NHCOCH₃ | H | CH₂C₆H₅ | H | C₆H₅ | 526 |
| 56 | H | NO₂ | H | H | —C₂H₄— | H | Cl | H | H | C₆H₅ | 450 |
| 57 | H | NO₂ | H | H | —C₂H₄— | NHCOCH₃ | H | C₂H₅ | H | *—(CH₂)₄— | 514 |
| 58 | H | NO₂ | H | H | —C₂H₄— | NHCOCH₃ | H | CH₂C₆H₅ | H | C₆H₅ | 507 |
| 59 | NO₂ | NO₂ | SCN | H | —C₂H₄— | CH₃ | OCH₃ | H | H | C₆H₅ | 601 |
| 60 | NO₂ | NO₂ | SCN | H | —C₂H₄— | NHCOCH₃ | OCH₃ | H | H | C₆H₅ | 621 |

### Mixture Examples

### Example M1

a) 30.2 g of the dye (1) of Example (I)-1 and 25.0 g of the dye of Example 1 were ground together with 300 ml of water and 53 g of ligninsulphonate (sodium salt) in a bead or sand mill for 3 hours and subsequently spray dried (entry temperature 130° C., exit temperature 60° C.). The powder thus obtained (about 100 g) with a residual moisture content of about 0.7% by weight is readily dispersible in water.

b) 0.4 g of the powder prepared above was treated together with 10 g of polyester textile material by a normal HT dyeing process at pH 4.5 and 130° C. for about 60 min. A blue polyester dyeing having very good fastnesses was obtained after washing, rinsing and drying.

### Example M2

Example M1 was repeated to prepare further dye mixtures for use in polyester-dyeing, except that 26 g of dye (1) of Example (I)-1 and 21 g of dye of Example 2 were used. A blue polyester dyeing having very good fastnesses was obtained.

### Example M3

Example M1 was repeated to prepare further dye mixtures for use in polyester-dyeing, except that 26 g of dye (1) of Example (I)-1 and 21 g of dye of Example 3 were used. A blue polyester dyeing having very good fastnesses was obtained.

The dyes of the Example (I)-2 to the Example (I)-5 may be used in the same way as described in the Mixture Examples M1 to M3 instead of the dye (1) of Example (I)-1 as described above.

### Example M4

Example M1 was repeated to prepare further dye mixtures for use in polyester dyeing.

Dye mixture Dark blue to navy:

49.7% (reckoned on dry pigment) of the dye of the formula (I)
24.3% (reckoned on dry pigment) of the dye of the formula

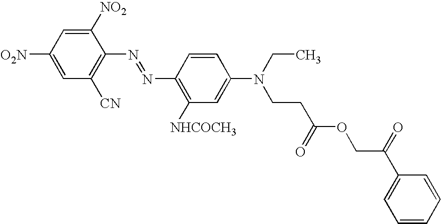

24.3% (reckoned on dry pigment) of the dye of the formula

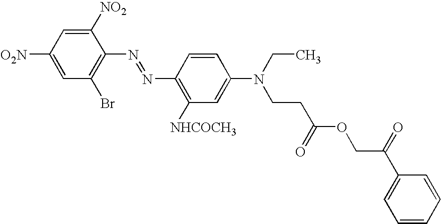

1.7% (reckoned on dry pigment) of the dye of the formula

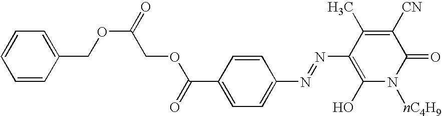

A navy polyester dyeing having very good fastnesses is obtained.

### Example M5

Example M1 was repeated to prepare further dye mixtures for use in polyester dyeing. Dye mixture Black:

about 15% (reckoned on dry pigment) of the dye of the formula (I),
about 23% (reckoned on dry pigment) of the dye of the formula

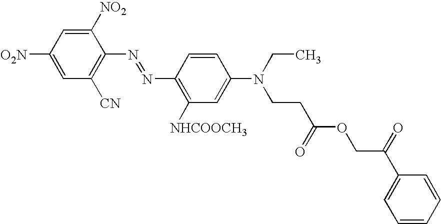

about 30% (reckoned on dry pigment) of the dye of the formula

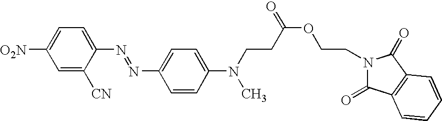

about 32% (reckoned on dry pigment) of the dye of the formula

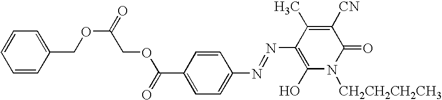

A black polyester dyeing having very good fastnesses is obtained.

### Example M6

Example M1 was repeated to prepare further dye mixtures for use in polyester dyeing.

Dye mixture Dark blue:

parts (reckoned on dry pigment) of the dye of the formula (I)
0.75 part of the dye of the formula

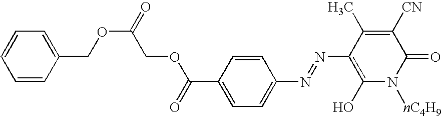

11 parts of the dye of the formula

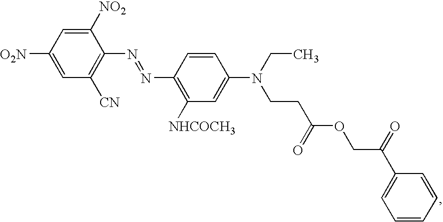

11 parts of the dye of the formula

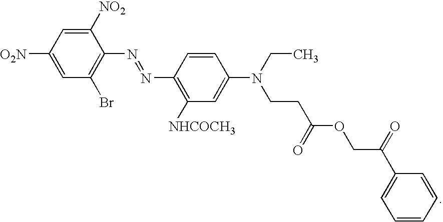

A dark blue polyester dyeing having very good wet fastness is obtained.

### Example M7

Example M1 was repeated to prepare further dye mixtures for use in polyester dyeing.

parts (reckoned on dry pigment) of the dye of the formula (I)
14 parts of the dye of the formula

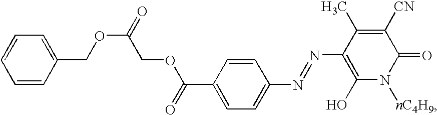

11 parts of the dye of the formula

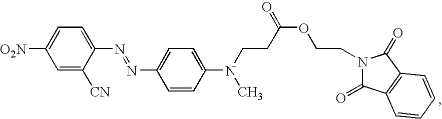

10 parts of the dye of the formula

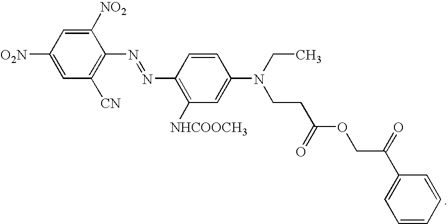

A black polyester dyeing having high build-up, high sublimation fastness and very good wet fastness is obtained.

1. A dye of the formula (I) 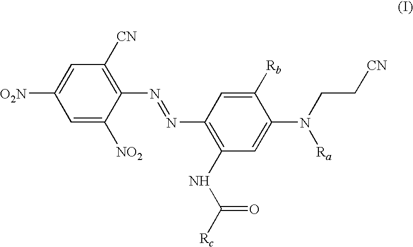
wherein
Rₐ is —C₆H₅-substituted C₁-C₄-alkyl,
R_{b} is methoxy or ethoxy
R_{c} is methyl or ethyl.

2. A dye according to claim 1,
wherein
Rₐ is a —C₆H₅-substituted C₁-C₂-alkyl,
R_{b} methoxy
R_{c} methyl.

3. A process for preparing a dye of formula (I), comprising the steps of: diazotizing an amine of the formula (II) to form a diazotized amine, 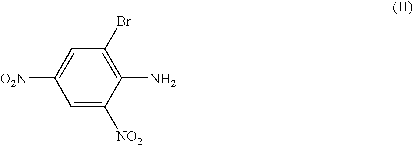
coupling the diazotized amine with a compound of the formula (III) 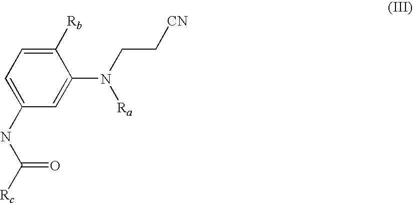
wherein
Rₐ is —C₆H₅-substituted C₁-C₄-alkyl,
R_{b} is methoxy or ethoxy
R_{c} is methyl or ethyl,
and subsequently replacing the Br substituent in the diazo component with —CN.

4. A process for dyeing and/or printing a hydrophobic fiber material, comprising the step of contacting the hydrophobic fiber material with at least one dye according to claim 1.

5. A process according to claim 4, for printing a hydrophobic fiber material, wherein the contacting step is performed by ink jet printing or hot melt ink jet printing.

6. A composition comprising at least one dye according to claim 1.

7. A composition according to claim 6, further comprising at least one dye of the formula (IV) 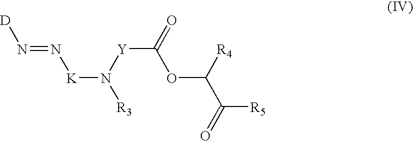
wherein
D is a diazo component derived from a substituted or unsubstituted aromatic amine,
K is an aromatic radical of the formula K₁, K₂ or K₃ 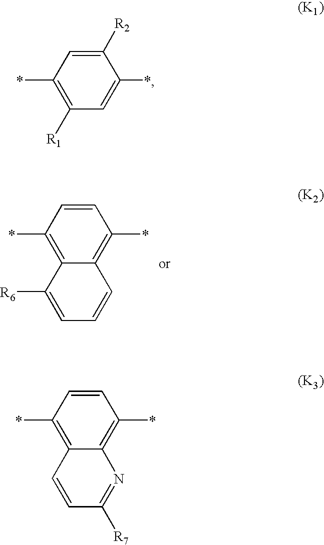
R₁ is hydrogen, chlorine, C₁₋₂-alkyl, C₁₋₂-alkoxy, hydroxyl or acylamino,
R₂ is hydrogen, C₁₋₄-alkoxy, C₁₋₂-alkoxyethoxy, chlorine, bromine or together with R₃ a group of the formula -*CH(CH₃)CH₂C(CH₃)₂— (* attached to the nucleus),
R₃ is hydrogen, C₁₋₆alkyl, C₃₋₄-alkenyl, chloro- or bromo-C₃₋₄-alkenyl, C₃₋₄-alkynyl, phenyl-C₁₋₃-alkyl, C₁₋₄-alkoxycarbonyl-C₁₋₃-alkyl, C₃₋₄-alkenyloxycarbonyl-C₁₋₃-alkyl, C₃₋₄-alkynyloxycarbonyl-C₁₋₃-alkyl, phenoxy-C₂₋₄-alkyl, halo-, cyano-, C₁₋₄-alkoxy-, C₁₋₄-alkylcarbonyloxy- or C₁₋₄-alkoxycarbonyloxy-substituted C₂₋₄-alkyl or a group of the formula —CH₂—CH(R₈)CH₂—R₉,
R₄ is hydrogen or C₁₋₂-alkyl,
R₅ is phenyl, wherein the phenyl may be substituted by one or two substituents selected from the group consisting of methyl, chlorine, bromine and nitro, or
R₅ combines with R₄ to form a c-pentanone or c-hexanone ring,
R₆ is hydrogen or hydroxyl,
R₇ is hydrogen or methyl,
R₈ is hydroxyl or C₁₋₄-alkylcarbonyloxy,
R₉ is chlorine, C₁₋₄-alkoxy, phenoxy, allyloxy or C₁₋₄-alkylcarbonyloxy,
Y is C₁₋₃-alkylene,
subject to the proviso that when K is a radical of the formula K₂ or K₃, R₃ is hydrogen.

8. A fiber material printed or dyed with at least one dye according to claim 1.

9. A dye according to claim 1, wherein Rₐ is benzyl substituted C₁-C₂-alkyl.

10. A process according to claim 4, wherein the hydrophobic fiber material is a polyester, a secondary acetate and/or a triacetate fiber material.
